(19) United States
(12) Patent Application Publication
(10) Pub. No.: US 2012/0280059 A1
(43) Pub. Date: Nov. 8, 2012

(54) Mission Critical Sanitizer

(76) Inventor: Jonathan Jan, Culver City, CA (US)

(21) Appl. No.: 13/099,754

(22) Filed: May 3, 2011

(51) Int. Cl. B05B 9/00; B01F 15/02

(52) U.S. Cl. 239/142; 366/176.1

(57) ABSTRACT

A mission critical sanitizing apparatus has a plurality of input pumps. At least two of the input pumps are a digital jet means. A water pump is for inputting water to a mixing chamber. The mixing chamber receives flow from the plurality of input pumps, and from the water pump. The plurality of input pumps provides digitally measured flow to a mixing chamber. The mixing chamber receives water from the water pump. The output pump pumps an output flow from the mixing chamber. A controller provides digital control to the plurality of input pumps and the controller controls the water pump and the output pump. A communications module has a communications protocol and receives configuration input from a user. Preferably, an HOCl concentration is between 20 ppm and 300 ppm and a pH of the output flow is in the range of 5.5-7.0.

### BACKGROUND

Machines for sanitizing have been used for a variety of applications such as water treatment and airflow treatment. A variety of public health dangers such as flesh-eating bacteria or different strands of viruses would become out of control on a large global scale without sanitizing equipment. Sanitizing machines in the past have titrated a variety of sanitizer solutions such as chlorine or an acid by releasing quantities into a stream of water or air.

Chlorine, particularly sodium hypochlorite solution (bleach), has been a commonly used disinfectant. It is also a hazardous material that can cause corrosion and health problems.

NaOCl+H2O------>HOCl+NaOH

The active ingredient in the bleach is HOCl (hypochorous acid). Being in the base solution of pH value 8-10, 80% of it exists in the form of OCl (hypochlorite ion) which does not have much sterilizing power.

HOCl<------>OCl⁻+H+

According to the publication Technologies For Upgrading Existing Or Designing New Drinking Water Treatment Facilities, US EPA. 1990. P. 62-69, the disclosure of which is incorporated herein by reference, disinfection is accomplished by HOCl's oxidizing reactions with organic matter. By tweaking the pH of the bleach solution to slightly acid, i.e.; between 5.5 and 7, a higher sanitizing effect can be obtained. (p. 67, fig. 5.1)

According to the publication Bleach Activates a Redox-Regulated Chaperone by Oxidative Protein Unfolding, J. Winter, et al. Molecular Cell, February 2005, p. 381-392, the disclosure of which is incorporated herein by reference, when a HOCl attaches to a DNA strand, the microorganism looses its ability to reproduce. According to lab data, 100 ppm hypochlorous solution at pH 7.3 can effectively sterilize bacteria within 3 minutes. It is considered safe and non-toxic according to EPA and FDA publication. It is also a very effective deodorizer.

A variety of different processes have been used for working with sanitizing mixtures. U.S. Pat. No. 7,261,821 to inventor Beardwood, issued Aug. 28, 2007, the disclosure of which is incorporated herein by reference, provides a fully automated process for efficiently treating an aqueous system with chlorine dioxide. Beardwood provided an algorithm for preparing sanitizing mixtures. Also, U.S. Pat. No. 7,458,204 issued Dec. 2, 2008 to inventor Ploughman discloses a dosing pump assembly using any mechanical membrane and electric drive. U.S. Pat. No. 7,278,836 issued Oct. 9, 2007 to Hammonds provides a metering pump.

A variety of inkjet print heads have been invented for printing on paper. For example, in U.S. Pat. No. 5,420,627 to Keefe, issued May 30, 1995, the disclosure of which is incorporated herein by reference, a print cartridge has a polymer tape with openings opening to nozzles where heater elements on a substrate eject ink out of the openings. The thermal print head is one method of printing, and there is also a piezoelectric method of ejecting ink by squeezing force as shown in U.S. Pat. No. 6,174,051 to Sakaida issued Jan. 16, 2001, the disclosure of which is incorporated herein by reference. Ultrasonic inkjet print heads can be piezoelectrically or thermally actuated. Electronic control has been used for controlling precise quantities of liquid dispensing. For example, in United States patent publication 2005/0037507, issued Feb. 17, 2005 to Gauer, the disclosure of which is incorporated by reference, a quantity of liquid dispensing is controlled on a surface of a chip.

For example, in U.S. Pat. No. 7,478,899 to Moynihan, issued Jan. 20, 2009, the disclosure of which is incorporated herein by reference, a piezoelectric ink jet head that includes a polymer film located between the piezoelectric element and the reservoirs in the jet body. A casing and nozzle plate form a hollow cavity in which liquid can be filled as shown in U.S. Pat. No. 5,666,141 to Matoba et al. issued Sep. 9, 1997, the disclosure of which is incorporated herein by reference.

An ink jet head having a plurality of nozzles through which fine particles of ink are jetted and the ink pump member having a plurality of ink chambers can change the pressure of the respective chambers as shown in U.S. Pat. No. 5,670,999 to Takeuchi et al. issued Sep. 23, 1997, the disclosure of which is incorporated herein by reference. For example, in U.S. Pat. No. 7,290,541 to Ivri et al. issued Nov. 6, 2007, the disclosure of which is incorporated herein by reference, a pressure-assisted breathing system comprises an aerosol generator for emitting aerosol particles into the circuit.

Water and water distribution systems in facilities and equipment are all subject to microbial contamination as shown in “Gf and An Overview of Oxicide: The Definitive Solution to Disinfection in facility Water Distribution Systems & Equipment” by Eric W. Christensen, published in February 2003, the disclosure of which is incorporated herein by reference. For example, for fundamental physics in wetting layers, one may wish to consult an article by senior scientist at Sandia National Laboratories Peter Feibelman published in Physics Today in February 2010, entitled “The first wetting layer on a solid,” the disclosure of which is incorporated herein by reference.

For chlorine chemical reaction basic chemistry, one may wish to consult pages 66 to 68 of Upgrading existing or designing new drinking water treatment facilities by James E Smith, the disclosure of which ins incorporated herein by reference.

The present invention aims to create a non-toxic, low cost, and easy to use sanitizer that will offer a first line of defense in a variety of public health applications.

### SUMMARY OF THE INVENTION

A mission critical sanitizing apparatus has a plurality of input pumps. At least two of the input pumps are a digital jet means. A water pump is for inputting water to a mixing chamber. The mixing chamber receives flow from the plurality of input pumps, and from the water pump.

The plurality of input pumps provides digitally measured flow to a mixing chamber. The mixing chamber receives water from the water pump. The output pump pumps an output flow from the mixing chamber. A controller provides digital control to the plurality of input pumps and the controller controls the water pump and the output pump. A communications module has a communications protocol and receives configuration input from a user. A diluted acid solution of citric acid or hydrogen chloride can be used for changing the pH of the sanitizing solution. Preferably, an HOCl concentration is between 20 ppm and 300 ppm and a pH of the output flow is in the range of 5.5-7.0.

The present invention can be used in a variety of different fields such as water treatment for both potable water and wastewater treatment. Chlorine usage can be reduced by 98%. Sterilizing commercial buildings and public gathering places through HVAC embedded applications is also possible. The present invention can be used for disinfecting and sterilizing medical and dental equipment, disinfecting poultry, dairy, hog and other livestock operations, disinfecting meatpacking facilities, disinfecting produce processing and packing facilities, and use as a general household disinfectant system.

This Mission Critical Sanitizer can be made by chemical titratingtitration. However, a digitally controlled machine can make it safe and easy for field installations according to user requirements. The mission-critical sanitizer uses a plurality of pumps which are preferably digital jet means similar to inkjet heads of commonly and commercially available inkjet printers. The pumps measure a sanitizing solution that is mixed in a mixing chamber and output from an output pump. Preferably, three input pumps input to a mixing chamber and then the sanitizing solution is output from an output pump. The output pump may lead to an outlet at a stream of water, or a spray nozzle in a flow of air. Additionally, an ultrasonic vaporizer can deliver the mist at the outlet.

A controller having multiple input sensors such as chemical sensors, temperature sensors, humidity sensors, acidity sensors, and pressure sensors can provide data to a controller for controlling the pumps. The controller can further include a communications module that has a wireless protocol, and Ethernet protocol or a USB protocol for receiving command instructions, and for software or firmware updates.

### BRIEF DESCRIPTION OF THE DRAWINGS

FIG. 1 is a diagram of a mixing chamber showing the three input pumps and one output pump.

FIG. 2 is a diagram of a controller and communications module in connection with pumps and sensors.

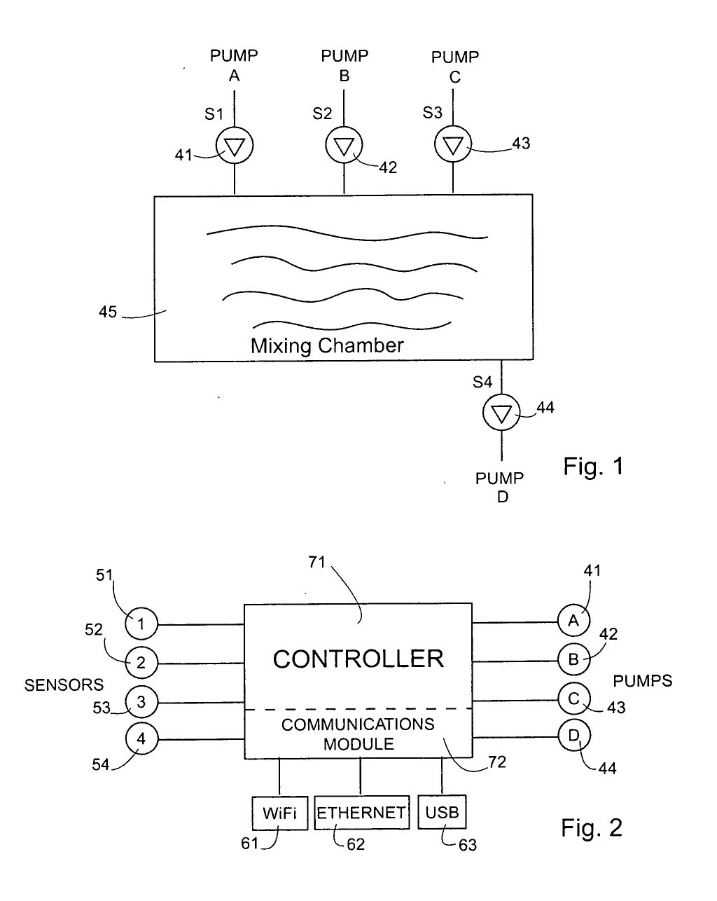

The following call out list of elements may serve as a reference for the figures.
41 First Pump
42 Second Pump
43 Water Pump, Third Pump
44 Output Pump, Fourth Pump
45 Mixing Chamber
51 First Sensor
52 Second Sensor
53 Third Sensor
54 Fourth Sensor
61 Wireless Protocol
62 Ethernet Protocol
63 USB Protocol
71 Controller
72 Communications Module

### DETAILED DESCRIPTION OF THE PREFERRED EMBODIMENT

A variety of disinfecting solutions can be created, for example a batch of 100 ml HOCl solution, at 2000 ppm can be made by mixing 3.300 ml of Bleach and 6%; 0.239 ml of HCl, 31.45% with 96.461 ml of water. The disinfecting solution can be digitally dispensed and diluted to 10 times to provide 1,000 ml, or 1 Liter of 200 ppm HOCl solution with a PH of about 6.0, +/−0.5. Depending on the application, this solution can be further diluted to minimum of 20 ppm.

The mission-critical sanitizer uses a plurality of pumps for the first pump and the second pump which are preferably digital jet means similar to inkjet heads of commonly and commercially available inkjet printers. The pumps measure a sanitizing solution that is mixed in a mixing chamber and output from an output pump. Preferably, three input pumps input to a mixing chamber and then the sanitizing solution is output from an output pump. The output pump may lead to an outlet at a stream of water, or a spray nozzle in a flow of air.

A first pump 41, a second pump 42, and a third pump 43 can introduce ingredients for a disinfecting solution into a mixing chamber 45 for output from an output pump which is the fourth pump 44. For example, the first pump 41 can measure bleach dispensing to the mixing chamber 45. The second pump 41 can measure dispensing of HCl to the mixing chamber 45. The third pump can dispense water to the mixing chamber 45. Given the relatively unequal amounts of liquid that are being dispensed, the size of the pump would vary according to the relative quantity required. The pump for the water may not be a digital jet means, if such means are inadequate in terms of price or flow rate. After mixing in the mixing chamber 45, the output pump 44 would output the sanitizing solution.

A controller 71 having multiple input sensors such as chemical sensors, temperature sensors, humidity sensors, acidity sensors, and pressure sensors can provide data to a controller for automatically and remotely controlling the pumps. There is preferably about four sensors, namely a first sensor 51, a second sensor 52, a third sensor 53, and a fourth sensor 54. The controller can further include a communications module 72 that has a wireless protocol 61, and Ethernet protocol 62 or a USB protocol 63 for receiving command instructions, and for software or firmware updates.

The first embodiment of the present invention is a digital titrating machine. This machine titrates and mixes liquid chemicals in a continuous batch process. Metering pumps in traditional liquid mixing machines are analog and require constant calibrations and do not have the accuracy required for mission-critical sanitizer applications.

A variety of digital jet means may be used as pumps for dispensing or diluting disinfecting solutions. Digital jet means includes thermal and ultrasonic devices known in the printing industry as inkjet print heads. Inkjet print heads are chosen to serve as digital metering pumps. Both the ultrasonic (Canon) and the thermal (HP) print heads are suitable as digital jet means. Although it may seem unorthodox and will void your warranty, for lower cost, Commercially available inkjet print heads are can be used as the digital jet means and multiply arranged in an array (such as a linear array) that could, for example, be mounted on a wall of a mixing chamber so that the sloshing of the water or other liquid inside the mixing chamber would take up the output of the array. Generally, in an ultrasonic digital jet means, an ultrasonic frequency is applied for dispensing liquid; and in a thermal digital jet means, a thermal application creates a bubble that sprays the liquid out of a head. These modern print heads can inject droplets a few pico liter in size as they are typically electronic chip based solutions. When working in combination with the sensors and controller, high precession can be achieved. This also enables high tolerance over variations of feedstock chemicals and even water quality. The quality of the output solution can be kept within tight specifications. This is important because if the pH of the solution falls below 5, toxic gases such as chlorine gas and trihalomethane could be released.

The system is generally comprised of a mixing chamber, sensors, pumps, and a controller. pH sensors S1, S2, S3, S4 are installed at the inlet of each pump. Values are fed to the controller in real time.

The fourth sensor S4 is useful in determining the acidity of the output disinfecting solution. The controller can be programmed to shut down, or issue a warning or e-mail notice if the acidity of the output of the disinfecting solution is in error, or not within prescribed limits.

In the best mode, sodium hypochlorite solution (bleach) is fed into the mixing chamber via digital metering pump A; hydrogen chlorite solution is fed into the mixing chamber via digital metering pump B; and clean water is fed into the chamber via metering pump C. The finished batch of is disinfecting solution discharged via pump D, which is the output pump.

The controller can be programmed to make the disinfecting solution with HOCl concentration between 20 ppm and 300 ppm and pH in the safe and effective range of 5.5-7.0. The controller has embedded WiFi connection for remote programming and control. It also has Ethernet and USB ports for field service and connections to other devices. The controller has at least one communications module which preferably has at least one communications protocol such as a wireless protocol, an Ethernet protocol or a USB protocol. The communications protocol preferably receives configuration input from a user for providing parameters for dispensing the components and ingredients of the sanitizing solution.

The second embodiment of the present invention provides an aerosol distribution version of the mission-critical sanitizer. Aerosol is the most effective and efficient way for room space sanitizing. The mist not only sanitizes the air, but when combined with an HVAC system, the sanitizer mist can be dispersed throughout open space so that all surfaces such as humans, animals, floor and walls can be covered. The HVAC ducts that are otherwise infested with germs and mold can also be sanitized.

Although mechanical pressurized misting nozzles can be used for misting disinfecting solution, it is preferred to use ultrasonic vaporizers to produce the aerosol mist after the disinfecting solution is discharged from the output pump. In the case where the present invention is embodied as a machine embedded in the HVAC system, the main controller will also control the volume and sequence of mist delivered. Optical sensors can be installed in the facility will allow facility management to monitor microorganism activities at remote locations.

Optionally, instead of using HCl to change the pH of the hypochlorous solution, citric acid can be used and may have better stability. The appropriate Citric acid, C6H8O7, has 3 ionizable groups and is commonly used as a buffer in chemical processes.

The following are empirical examples from titration.

Volumetric table for making 2000 ppm hypochlorous solutions at various pH values

| pH | Vol 6% bleach | Vol 3.145% HCl | Vol water |
|---|---|---|---|
| 8 | 3.3 ml | .6 ml | 96.1 ml |
| 7.5 | 3.3 ml | 1.2 ml | 95.5 ml |
| 7 | 3.3 ml | 1.9 ml | 94.8 ml |
| 6.5 | 3.3 ml | 2.5 ml | 94.2 ml |
| 6 | 3.3 ml | 2.65 ml | 94.05 ml |
| 5.5 | 3.3 ml | <2.7 ml | 94 ml |
| pH | Vol 6% bleach | Vol 5% citric acid (w/v) | Vol water |
| 8 | 3.3 ml | .7 ml | 96 ml |
| 7.5 | 3.3 ml | 1.5 ml | 95.2 ml |
| 7 | 3.3 ml | 2.45 ml | 94.25 ml |
| 6.5 | 3.3 ml | 3.2 ml | 93.5 ml |
| 6 | 3.3 ml | 3.8 ml | 92.9 ml |
| 5.5 | 3.3 ml | 4.5 ml | 92.2 ml |

It is also possible to combine the use of the HCl with the citric acid. Therefore, while the presently preferred forms of the invention has been shown and described, and several modifications thereof discussed, persons skilled in this art will readily appreciate that various additional changes and modifications may be made without departing from the spirit of the invention, as defined and differentiated by the following claims.

1. A mission critical sanitizing apparatus comprising:
a. a plurality of input pumps, wherein at least two of the input pumps are a digital jet means;
b. a water pump for inputting water;
c. a mixing chamber that receives flow from the plurality of input pumps, and from the water pump, wherein the plurality of input pumps provides digitally measured flow to a mixing chamber, wherein the mixing chamber receives water from the water pump;
d. an output pump for pumping an output flow from the mixing chamber; and
e. a sanitizing solution created in the mixing chamber, wherein the sanitizing solution includes water, a bleach solution and an acid solution, wherein the solution a diluted acid solution.

2. The mission critical sanitizing apparatus of claim 1, wherein the acid solution is a Citric acid solution; wherein the plurality of input pumps comprises a first pump and a second pump, wherein the first pump pumps the bleach solution, and wherein the second pump pumps the Citric acid solution.

3. The mission critical sanitizing apparatus of claim 1, further comprising a controller providing a digital control to the plurality of input pumps, and wherein the controller controls the water pump and the output pump.

4. The mission critical sanitizing apparatus of claim 3, further comprising a sanitizing solution created in the mixing chamber, wherein the sanitizing solution includes water, a bleach solution and a Citric acid solution wherein a pH of the output flow is in the range of 5.5-7.0.

5. The mission critical sanitizing apparatus of claim 4, further comprising a sanitizing solution created in the mixing chamber, wherein the sanitizing solution includes water, a bleach solution and a Citric acid solution; wherein the plurality of input pumps comprises a first pump and a second pump, wherein the first pump pumps the bleach solution, and wherein the second pump pumps the Citric acid solution.

6. The mission critical sanitizing apparatus of claim 1, further comprising a controller providing a digital control to the plurality of input pumps, and wherein the controller controls the water pump and the output pump; and further comprising a communications module, wherein the communications module has a communications protocol.

7. The mission critical sanitizing apparatus of claim 1, wherein the acid solution is a Citric acid solution; wherein the plurality of input pumps comprises a first pump and a second pump, wherein the first pump pumps the bleach solution, and wherein the second pump pumps the Citric acid solution, further comprising a controller providing a digital control to the plurality of input pumps, and wherein the controller controls the water pump and the output pump; and further comprising a communications module, wherein the communications module has a communications protocol, wherein the communications protocol receives configuration input from a user.

8. The mission critical sanitizing apparatus of claim 1, wherein the sanitizing solution includes water, a bleach solution and a Citric acid solution; wherein the plurality of input pumps comprises a first pump and a second pump, wherein the first pump pumps the bleach solution, and wherein the second pump pumps the Citric acid solution.

9. The mission critical sanitizing apparatus of claim 1, further comprising a controller providing a digital control to the plurality of input pumps, and wherein the controller controls the water pump and the output pump; and further comprising a communications module, wherein the communications module has a communications protocol, wherein the communications protocol receives configuration input from a user wherein a HOCl concentration is between 20 ppm and 300 ppm and a pH of the output flow is in the range of 5.5-7.0.

10. The mission critical sanitizing apparatus of claim 1, wherein the sanitizing solution includes water, a bleach solution and an HCl acid solution.

11. The mission critical sanitizing apparatus of claim 10, further comprising a controller providing a digital control to the plurality of input pumps, and wherein the controller controls the water pump and the output pump; and further comprising a communications module, wherein the communications module has a communications protocol, wherein the communications protocol receives configuration input from a user.

12. The mission critical sanitizing apparatus of claim 11, further comprising an ultrasonic mister embedded in an HVAC system for dispersing the sanitizing solution.

13. The mission critical sanitizing apparatus of claim 11, further comprising an ultrasonic mister for airborne dispersal of the sanitizing solution.

14. The mission critical sanitizing apparatus of claim 11, further comprising a pressurized sprayer nozzle for airborne dispersal of the sanitizing solution.

15. The mission critical sanitizing apparatus of claim 11, further comprising a sanitizing solution created in the mixing chamber, wherein the sanitizing solution includes water, a bleach solution and a HCl acid solution; wherein the plurality of input pumps comprises a first pump and a second pump, wherein the first pump pumps the bleach solution, and wherein the second pump pumps the HCl acid solution.

16. The mission critical sanitizing apparatus of claim 15, further comprising an ultrasonic mister embedded in an HVAC system for dispersing the sanitizing solution.

17. The mission critical sanitizing apparatus of claim 15, further comprising an ultrasonic mister for airborne dispersal of the sanitizing solution.

18. The mission critical sanitizing apparatus of claim 15, further comprising a pressurized sprayer nozzle for airborne dispersal of the sanitizing solution.

19. The mission critical sanitizing apparatus of claim 18, further comprising an ultrasonic mister embedded in an HVAC system for dispersing the sanitizing solution.

20. The mission critical sanitizing apparatus of claim 18, further comprising an ultrasonic mister for airborne dispersal of the sanitizing solution.
